(19) United States
(12) Patent Application Publication
(10) Pub. No.: US 2012/0144424 A1
(43) Pub. Date: Jun. 7, 2012

(54) ON-DEMAND USER-INTERFACE

(76) Inventors: Prasanna Ganesan, Burlingame, CA (US); Todd Fuller, Union City, CA (US)

(21) Appl. No.: 13/313,973

(22) Filed: Dec. 7, 2011

Related U.S. Application Data
(60) Provisional application No. 61/420,577, filed on Dec. 7, 2010.

(51) Int. Cl. H04N 21/00

(52) U.S. Cl. 725/40

(57) ABSTRACT

Embodiments described herein provide a method and system for creating and displaying a media presentation. Data is received corresponding to a video program from a content delivery network. The video program is displayed on a display device. A plurality of display features are generated and displayed on the display device concurrently with the video program. The display features are selectable, and in response to a user selecting a display feature, content from a specific site associated with the selected display feature is retrieved. The retrieved content is concurrently displayed with the video program.

### RELATED APPLICATIONS

This application claims benefit of priority to U.S. Provisional Patent Application No. 61/420,577, filed Dec. 7, 2010, entitled “On-Demand User-Interface;” the aforementioned priority application being hereby incorporated by reference in its entirety.

### TECHNICAL FIELD

The disclosed embodiments relate generally to creating a media presentation and delivering content to a display device.

### BACKGROUND

Video-on-demand (VOD) has morphed over recent years. Before, VOD relied heavily on set-top boxes and dedicated devices. At the same time, much of the content that has traditionally been available on the television is now available on the internet. Websites from the internet such as www.youtube.com and www.facebook.com provide much interest to users.

### BRIEF DESCRIPTION OF THE DRAWINGS

FIG. 1 illustrates a system for creating and displaying a media presentation, according to an embodiment.

FIG. 2 illustrates a method for creating and displaying a media presentation, under an embodiment.

FIG. 3 illustrates another method for creating and displaying a media presentation, under another embodiment.

FIG. 4 illustrates a method for creating and displaying a media presentation with an informational search site, under an embodiment.

FIG. 5 illustrates a method for interacting with a social networking environment on the media presentation, according to an embodiment.

FIG. 6 illustrates a hardware illustration of a device for implementing an architecture such as described with FIG. 1, under an embodiment.

FIG. 7 illustrates a media presentation that includes a plurality of display features, under an embodiment.

FIG. 8 illustrates a media presentation under another embodiment.

FIG. 9 illustrates retrieved content corresponding to a news article under an embodiment.

FIG. 10 illustrates a media presentation that has a display feature for a social website, according to an embodiment.

FIG. 11 illustrates retrieved content corresponding to a profile page of a user, according to an embodiment.

FIG. 12 illustrates another retrieved content corresponding to a social website, under another embodiment.

FIG. 13 illustrates a video information page under an embodiment.

FIG. 14 illustrates a media presentation that has a display features for another social website, according to an embodiment.

FIG. 15 illustrates retrieved content corresponding to a social website, according to an embodiment.

FIG. 16 illustrates an ordering page with various video programs available from a content delivery network, under an embodiment.

FIG. 17 illustrates a video information page under another embodiment.

FIG. 18 illustrates an informational search site, according to an embodiment.

### DETAILED DESCRIPTION

Embodiments described herein provide for a method and system for creating and displaying a media presentation on a display device. The system is configured to receive data corresponding to a video program and display the video program using that data. In addition, the system generates display features that are selectable by the user. Each of the display features corresponds to a specific site, and if the user selects one of the display features, the system retrieves content from the site corresponding to the selected display feature and concurrently displays that content with the displayed video program. The media presentation can be displayed on a television and a user is enabled to control the media presentation through use of a remote control device.

Other embodiments herein provide for a method and system for creating a media presentation and displaying the media presentation on a display device by displaying a video program after a user selects the video program from the retrieved content. In one embodiment, the system generates display features that are displayed on a display device. Each of the display features corresponds to a specific site and is selectable by a user. In response to the user selecting one of the display features, the system retrieves content from the corresponding site associated with that feature and displays the retrieved content on the display device. The system also enables the user to browse the retrieved content and select a video program from the retrieved content. In response to the user selecting a video program, the system receives data corresponding to the video program from a content delivery network and concurrently displays the video program with the retrieved content on the display device.

In some embodiments, the displayed video program is a high-definition quality video program. The video program can be a movie, a movie trailer, a television program, or a video clip. The data corresponding to the video program may also be received by streaming. In other embodiments, the system is configured to automatically change the viewing size of the displayed video program when content is retrieved from a specific site. Still further, the system may enable the user to browse the retrieved content while currently displaying the video program.

Embodiments also provide for a method for creating a media presentation to enable a user to navigate a video information page and concurrently retrieve content from an informational search site. In one embodiment, the system is configured to receive data corresponding to a video information page from a content delivery network. The system displays the video information page on a display device and enables the user to browse the video information page in order to select a video program for playback. The video information page can also include selectable links that are associated with an informational search site. In response to the user selecting the link associated with the informational search site, the system retrieves content from the informational search site that corresponds to a video program. The system can present the retrieved content from the informational search site as part of the media presentation.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments can be carried and/or executed. In particular, the numerous machines shown with embodiments include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and personal digital assistants (PDAs)), and magnetic memory. Computers, terminals, and network enabled devices (e.g. mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

### System Overview

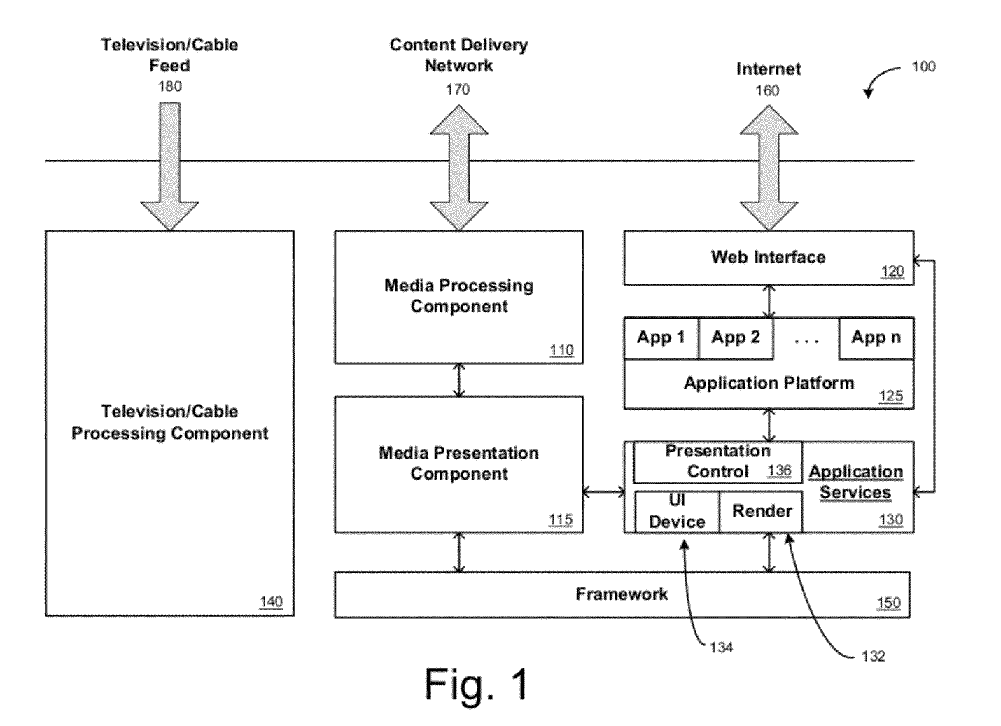

FIG. 1 illustrates a system for creating and displaying a media presentation on a display device, according to an embodiment. A system such as illustrated with FIG. 1 may be implemented on a display device with ability for network connectivity. The display device may correspond to, for example, a personal computer, a laptop computer, or a television with integrated capabilities for connecting to a network or the Internet. The television (TV) can be a cathode ray tube (CRT) TV, a digital light processing (DLP) TV, a liquid crystal display (LCD) TV, a plasma display TV, a light emitting diode (LED) TV, or other types of televisions with various types of display.

In FIG. 1, system 100 includes a media processing component 110 and a media presentation component 115. The media processing component 110 receives data from a content delivery network 170. The data can correspond to a video program that a user has selected for playback on the display device. In one embodiment, the media processing component 110 receives data by streaming from the content delivery network 170. The video program can be a movie, a movie trailer, a television program, a video clip, or the like. The video program can be one of high definition quality (such as 720p, 1080p, or 1080i resolutions, or blu-ray quality, for example) or standard definition. The media processing component 110 receives the data, provides a buffer for the data, processes the data, and communicates with the content delivery network 170 to relay user commands to the network 170. This enables the media presentation to display video on-demand.

The media processing component 110 processes the data received from the content delivery network 170 to enable playback of a video program corresponding to the data. The media processing component 110 relays the processed data to the media presentation component 115 for playback on the display device. The media presentation component 115 displays the video program on the display device using the processed data from the media processing component. For example, if the user requests a movie from the content delivery network 170 for playback, the media processing component 110 receives data corresponding to the requested movie and processes the data. The media presentation component 115 receives the processed data and enables playback of the requested movie on the display device.

In one embodiment, the data that is received by the media processing component 110 can also correspond to a video information page or an ordering page related to video programs available from the content delivery network 170. The ordering page displays a number of different video programs that a user can order (rent or purchase, for example) from the content delivery network 170. The user can request a video program from the content delivery network by first browsing/searching the ordering page and then by selecting a video program for playback. The ordering page is displayed on the display device by the media presentation component 115. Once the user determines which video program he or she would like to order by selecting the video program from the ordering page, the media presentation component 115 can display a video information page so that the user can view more details about the selected video program.

In one embodiment, a video information page can present a variety of different information about a particular movie (such as a summary of the movie, the actors starring in the movie, the directors or producers, the release date of the movie, the length of the movie, the price to order the movie, etc.). It can also have a link for ordering the corresponding video program from the content delivery network 170 and a link for watching a preview or a trailer.

System 100 also includes a web interface 120, an application platform 125, and application services 130. The web interface 120 provides an interface for system 100 to enable communications with the Internet or network 160. As discussed above, the display device has integrated capabilities for connecting to a network or the Internet. The web interface 120 communicates with the application platform 125 and sends data corresponding to various sites from the Internet 160 to the application platform 125. In one embodiment, the web interface 120 can communicate with the network or the Internet 160 wirelessly (e.g., using wireless communication standards such as IEEE 802.11, or some other means of wireless communication). The application platform 125 receives data corresponding to various sites from the Internet 160 and uses this data to generate a plurality of display features. Individual display features can correspond to a specific site available on the Internet 160. For example, the application platform 125 can generate a first display feature that corresponds to www.espn.com, a second display feature that corresponds to www.pandora.com, and a third display feature that corresponds to www.youtube.com. The display features (alternatively referred to as Apps) are displayed on the display device and the display features are selectable by a user.

The user can select, launch or perform other functions on an application by operating a remote control device. The remote control device can, for example, provide binary user input (e.g., selection input) that can be interpreted as (i) launch application, or (ii) enter input for application. In one embodiment, the remote control device can be a television remote control with additional capabilities. The remote control device may also function like to a computer mouse. In another embodiment, the remote control device can be a joystick.

In some embodiments, some individual Apps are represented by a graphic image corresponding to the specific site associated with that App. For example, the application platform 125 can generate App 1, App 2, or App n to display on the display device. App 1 can correspond to www.cnn.com, for example, and the graphic image could be the logo or trademark of CNN®. App 2 can correspond to www.facebook.com, and the graphic image could be the logo or trademark of Facebook®. In another embodiment, the graphic images resemble a portion of or contain similar colors of the logo, symbol, or trademark, for example, of the corresponding site.

Application services 130 enables a user to control system 100 and access the media presentation on the display device. Application services 130 includes a rendering component 132, user interface (UI) device component 134, and presentation control 136. The rendering component 132 receives information corresponding to the generated display features from the application platform 125 and displays the display features (or Apps) on the display device. The Apps are displayed on the display device concurrently with the video program as part of the media presentation. As discussed above, the media presentation component 115 displays the video program and/or the video information page and/or the ordering page. According to some embodiments, the media presentation is configured to enable the concurrent display of these features with the Apps. In one embodiment, the Apps are displayed in a column on the left side or right side of the display window of the display device (or anywhere else on the display device). The Apps can also be displayed in a row on the top or the bottom of the display window, or can be displayed in both rows and columns. In another embodiment, the location and configuration of the Apps are configured by the user, or are set to a default setting. The Apps can be displayed concurrently with the video program by overlaying the Apps on at least a portion of the displayed video program. The user may also control the media presentation to display only a certain number of Apps or the most popular Apps, or the newest Apps, or other configurations of displaying the Apps depending on user preference.

In some embodiments, the media presentation is structured so that the Apps are semi-transparent to allow a user to see the displayed video program overlaid by the Apps. In some embodiments, the displayed video program is not overlaid by the Apps, but is positioned so that both the Apps and the displayed video program are presented on the display device. For example, the Apps can be displayed on a portion of the display device while the concurrently displayed video program is reduced in size.

The rendering component 132 and the UI device component 134 communicate with each other to enable the user to control and access the media presentation on the display device. In one embodiment, the UI device component 134 communicates with a dedicated remote control device of the display device to enable a user to browse the Apps, select one or more Apps, and/or select video programs for playback on the display device. Using the remote control device, the user can browse and/or select a video program to be played back on the display device from an ordering page, browse the plurality of Apps, and/or select one or more of the Apps to launch or perform other functions using the application. In another embodiment, the user can operate the remote control device to choose which Apps to add or delete to the media presentation. If a user accesses the media presentation and requests to add one or more Apps, application services 130 will communicate the user request to the application platform 125 to generate additional Apps for displaying on the display device. Depending on the user selections, the UI device component 134 signals information to the rendering component 132 to display the Apps on the display device. This enables a user to customize the media presentation.

In one embodiment, the user can customize the media presentation on system 100 by using application services 130. The UI device component 134 provides a translation of device commands from a remote control device. As discussed previously, the rendering component 132 can display the Apps on the media presentation depending on the user's preference and/or default settings. In some embodiments, the Apps are displayed in a row or a column, or both in rows and columns, so that the list of Apps is scrollable from left to right and vice versa, or up and down and vice versa. The media presentation can hide some of the Apps so that the hidden Apps only show up when the user scrolls in a direction. This enables the user to have a large number of Apps available on the media presentation instead of being limited by the screen size of the display device. In other embodiments, the media presentation is customizable to allow for the user to add or delete Apps, change the order of Apps that are displayed, and change the size and colors of the Apps.

Application services 130 also controls the retrieving of content from the Internet or network 160 through use of the web interface 120. As discussed previously, some of the display features or Apps correspond to a specific site available on the Internet 160. When a user selects an App from the media presentation, the UI device component 134 receives the selection and signals application services 130 to retrieve content corresponding to the selected App from the Internet 160. The selection from the user may correspond to selection input, that can highlight (or place in focus) and/or select actions for the user operating a remote control device. Application services 130 communicates with the web interface 120, which retrieves the content corresponding to the selected App from the Internet 160.

The rendering component 132 displays the retrieved content on the display device. In one embodiment, the retrieved content can be the website corresponding to a selected App. For example, if a user selected the CNN® App corresponding to www.cnn.com, the retrieved content can be the actual website provided on the Internet. In another embodiment, the retrieved content can be a modified version of the website for displaying on the display device. For example, if the user selected the CNN® App for www.cnn.com, the retrieved content can comprise a scrollable list of selectable headline news with a short title or image, instead of the actual website itself, or just one headline news for a specific genre.

In some embodiments, the rendering component 132 can display the Apps and the retrieved content on the display device concurrently with the video program, which is displayed by the media presentation component 115, as discussed previously. In other embodiments, the rendering component 132 can display just the selected App and the retrieved content in a smaller, modified form, so that the concurrently displayed video program can be in a much larger viewing size.

In one embodiment, application services 130 also enables the user to input information on the retrieved content and update the corresponding website on the internet. The user can browse the retrieved content through use of a remote control device. The UI device component 134 translates the commands from the remote control device (e.g., selection input or other) to enable the user to browse and/or select Apps, and to enable the user to browse and/or input information into the retrieved content. If a user enters input information into the retrieved content, application services 130 communicates the information to the web interface 120. The web interface 120 sends the information to the Internet 160 to update the website with the input information. For example, if the user is browsing retrieved content corresponding to www.facebook.com, the user can “write” on a friend's wall, or update his or her own profile status. When the user enters text to update his or her profile status, application services 130 processes the user inputs and communicates this information to the web interface 120. The web interface 120 sends the information to the Internet 160 to effectuate a change in the user's profile status on the Internet.

As discussed previously, the media presentation component 115 can display an ordering page related to video programs available from the content delivery network 170. A user can view the ordering page by selecting an App that corresponds to the content delivery network 170 (e.g., an App that shows the user available video programs for playback from the content delivery network 170) using the remote control device. Because application services 130 also communicates with the media presentation component 115, the user can use the remote control device to also browse the ordering page.

Presentation control 136 enables system 100 to control the media presentation that is displayed on the display device. Presentation control 136 communicates with the UI device component 134 to determine what selections or actions have been made or performed by the user. Presentation control 136 also communicates with the media presentation component 115 to control the media presentation (e.g., change the viewing size of the displayed video program when content is retrieved from a specific site, or automatically pause the displayed video program in some cases). Presentation control 136 can also alter the location of the viewing window of the displayed video program or cause the retrieved content to overlay or be overlaid by the displayed video program. For example, if a user requests the playback of a movie (e.g., a motion picture) from the content delivery network 170, the media processing component 110 receives data corresponding to the movie from the content delivery network 170, and the media presentation component 115 displays the movie on the display device using the data. While the movie is being played back on the display device, the user can access the media presentation and browse the plurality of Apps using a remote control device. Presentation control 136 controls how the Apps and the displayed video program are concurrently displayed on the display device. Depending on how the user customized the media presentation or how the default settings are configured, presentation control 136 can reduce the size of the viewing window of the displayed movie and/or move the location of the viewing window displaying the movie based on the requirements of the Apps. In other embodiments, as discussed above, presentation control 136 enables the Apps to be semi-transparent and to overlay a portion of the viewing window of the displayed movie.

When the user selects an App, application services 130 also communicates with the web interface 120 to retrieve content corresponding to the selected App from the Internet 160. The rendering component 132 displays the retrieved content corresponding to the selected App and application services 130 enables a user to browse the retrieved content (using the UI device component 134). In one embodiment, presentation control 136 controls the media presentation so that the retrieved content is displayed concurrently with the displayed video program (like the displayed Apps). Presentation control 136 can reduce the viewing window of the displayed video program and/or move the location of the viewing window based on the requirements of the retrieved content. In this way, the media presentation is adjusted so that the retrieved content can displayed on the display device without interrupting the playback of the video program. As discussed previously, the retrieved content can be formatted to be a modified version of the content found on a corresponding website. In one embodiment, when application services 130 retrieves content corresponding to a selected App, presentation control 136 automatically reduces the size of the viewing window of the video program and/or moves the location of the viewing window based on the requirements of the retrieved content, or partially overlays the retrieved content over the video program. In another embodiment, the user can customize the size and location of the viewing window of the video program.

System 100 is also configured to enable the user to control the video program displayed on the display device. As discussed previously, when a user requests playback of a video program, the data corresponding to the video program is retrieved from the content delivery network 170. The media processing component 110 processes the data and the media presentation component 115 displays the video program using the processed data on the display device. In some embodiments, this enables the media presentation to display video on-demand. While the video program is being played back on the display device, application services 130 enables the user to control the video program (e.g., allowing the user to pause, stop, play, rewind, or fast-forward the video program). The user may stop the playback of the video program and continue watching it at a later time. In one embodiment, the user can control the video program while the media presentation concurrently displays Apps and/or retrieved content corresponding to a selected App.

As discussed above, the retrieved content can be the actual website that corresponds to a selected App, or can be a modified version of the content from the website. When the rendering component 132 displays the retrieved content on the display device, the user can browse the retrieved content using a remote control device. The UI device component 134 translates commands from the remote control device to enable the user to navigate the retrieved content as well as the Apps themselves. In some embodiments, the user can browse the retrieved content and select links found on the retrieved content to get to other content. For example, if the user selects the Facebook® App corresponding to www.facebook.com, the retrieved content can comprise the home page that includes a scrollable list of headlines and/or notifications of the user's friends from the user's Facebook® account. The user can browse the scrollable list of headlines and/or notifications on the retrieved content and select links found on the retrieved content (e.g., a link can be a friend's name so that when the user selects that link, web interface 120 retrieves content corresponding to the friend's profile page). When the user selects links from the retrieved content, application services 130 communicates with the web interface 120 to retrieve other content corresponding to the selected links. Similarly, in another example, if the user selects the Associated Press® App corresponding to www.ap.org, the retrieved content can comprise a scrollable list of recent news and/or hot topics. The user can browse the list of recent news and/or hot topics from the retrieved content and can select one or more links found on the retrieved content to get to a news article, for example. In another example, the rendering component 132 can display the retrieved content from www.ap.org in a smaller, modified version to show one headline with different categories of news.

In another embodiment, the user can access the media presentation to request other video programs from either the content delivery network 170 or the Internet/network 160. As discussed above, an App can correspond to a specific website that is found on the Internet. Using system 100, a user can request content from a website that contains media files or video programs, and display the media file (such as an image or photograph, or a music file) or video program on the display device. For example, a user can select an App that corresponds to www.youtube.com, and search for and/or select video programs available on the retrieved content corresponding to www.youtube.com. If the user selects a video clip from the retrieved content for playback, application services 130 communicates with the web interface 120 to retrieve data corresponding to the selected video clip from the Internet 160. Application services 130 receives the data and causes the media presentation component 115 to display the selected video clip on the display device. In one embodiment, requesting a video clip from either the Internet 160 or a second video program from the content delivery network 170 while a video program is already playing automatically stops or pauses the video program before starting the selected video clip or the second video program.

In other embodiments, the media presentation component 115 can display an ordering page corresponding to the content delivery network 170. The ordering page can be displayed by a designated button from the remote control, for example, or when a user selects an App that corresponds to the content delivery network 170. The user can browse the ordering page for video programs that are available for playback from the content delivery network 170. The user can select a video program for playback from the ordering page and the media processing component 110 retrieves data corresponding to the selected video program from the content delivery network 170. The media processing component 110 processes the data and relays the data to the media presentation component 115 for displaying on the display device.

The ordering page includes links for other pages and allows a user to browse video programs available from the content delivery network 170. For example, the video programs available from the content delivery network 170 can be shown as movie posters or DVD covers or some other graphic image that can be selected. When a user selects a movie poster, the media presentation component 115 can display a video information page which displays information about the selected movie (such as the actors starring in the movie, the directors or producers, the release date of the movie, the length of the movie, the price to order the movie, etc.). Another link may be for a trailer page that displays the trailer for video programs available from the content delivery network 170. In other embodiments, the ordering page may also display a link for ordering a video program from the content delivery network 170 without viewing the corresponding video information page. The ordering page may also include links that enable the user to explore a catalog, or view the video programs that have been frequently viewed, or added to the content delivery network 170 for playback.

When the user selects a video program for playback from the content delivery network 170, the media processing component 110 requests data corresponding to the selected video program and receives the data from the content delivery network 170. In one embodiment, when the user selects to view a trailer for a movie while a video program is playing on the display device, for example, media presentation component 115 automatically stops or pauses the displayed video program and plays back the trailer for the movie on the display device. In another embodiment, the trailer for the movie can be played back on a viewing window on the ordering page or video information page of the media presentation.

System 100 also includes a framework 150. Framework 150 provides user interface features system wide that are independent of the display features and the displayed video program. The user interface features are part of the media presentation and are configured to allow the user to easily access and navigate the media presentation on the display device. In some embodiments, the user interface features can be customizable by the user (e.g., the user can select the color of the interface features). The media presentation component 115 and application services 130 exchange information with framework 150 so that the displayed video programs and the display features (or Apps) can be properly arranged with the user interface features.

FIG. 1 also illustrates an embodiment where system 100 extends to a television/cable feed so that a user can view television programming on the display device. System 100 includes a television/cable processing component 140 that receives data from a television/cable feed 180. The data from the television/cable feed 180 corresponds to a television program. The television/cable feed 180 can be a cable feed, a satellite feed, an over air feed, or other types that are broadcasted by a provider. System 100 enables a user to view television programming on the display device while browsing and/or selecting display features that are concurrently displayed with the television program. When a user selects an App on the media presentation, presentation control 136 can reduce the size of the viewing window of the television program and/or move the location of the viewing window displaying the television program based on the requirements of the selected App. As discussed above, in some embodiments, the Apps may be semi-transparent so that the television program will not be interrupted by the user browsing the Apps on the media presentation.

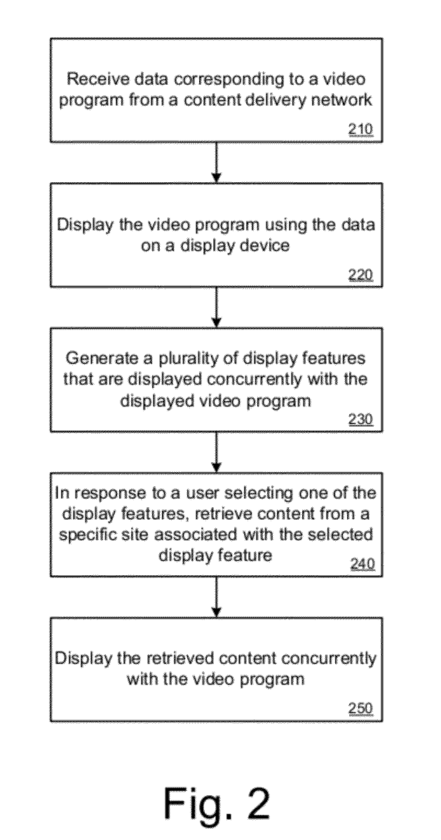

FIG. 2 illustrates a method for creating and displaying a media presentation, under an embodiment. A method such as described with FIG. 2 may be implemented using, for example, elements shown and described with FIG. 1. As such, reference to elements of FIG. 1 is intended to illustrate only suitable elements for performing a step or sub-step being described.

In step 210, system 100 receives data corresponding to a video program from a content delivery network. This can be done in response to a user selecting the video program from a list of video programs available from the content delivery network 170. In one embodiment, the list of video programs available can be found on an ordering page and the user can select a video program from the ordering page for playback. Media processing component 110 receives data corresponding to the video program from the content delivery network 170 and processes the data.

The media presentation component 115 receives the processed data from the media processing component and displays the video program (using the processed data) on a display device (step 220). As discussed above, the video program can be a (i) a movie, (ii) a movie trailer, (iii) a television program, or (iv) a video clip that is available from the content delivery network. The display device may correspond to, for example, a personal computer, a laptop computer, or a television with integrated capabilities for connecting to a network or the Internet.

System 100 also comprises a web interface 120 to communicate with the Internet or network. The web interface 120 communicates with the application platform 125 and sends data corresponding to various sites from the Internet to the application platform 125. The application platform 125 uses this data to generate a plurality of display features (step 230). These display features (or Apps) are displayed concurrently with the displayed video program on the display device. Rendering component 132 displays the Apps on the display device and presentation control 136 controls the media presentation. The user can browse and/or select one or more Apps through use of a dedicated remote control device. UI device component 134 translates the commands from the remote control device to enable the user to move between Apps and select one or more Apps.

In step 240, in response to a user selecting one of the display features, content is retrieved from a specific site associated with the selected display feature. When the user selects a display feature, application services 130 communicates with the web interface 120 to retrieve content corresponding to the selected display feature from the Internet. In one embodiment, the retrieved content can be the website corresponding to a selected App. In another embodiment, the retrieved content can be a modified version of the website for displaying on the display device.

After retrieving content from a specific site associated with the selected display feature, the retrieved content is displayed concurrently with the video program (step 250). Rendering component 132 displays the retrieved content on the display device concurrently with the displayed video program. Presentation control 136 can reduce the viewing window of the displayed video program and/or move the location of the viewing window based on the requirements of the retrieved content. In this way, the media presentation allows for the Apps and retrieved content to be displayed on the display device without interrupting the playback of the video program.

Alternatively, the steps in FIG. 2 can also apply to television/cable feeds from a television or cable provider. System 100 can receive data corresponding to a television program from a cable feed or satellite feed, for example, and display the television program on the display device. Application platform 125 generates the display features and rendering component 132 displays the display features on the display device as part of the media presentation. The display features are concurrently displayed with the television program and the user can browse and/or select the display features while the television program is being displayed. In response to the user selecting a display feature, application services 130 retrieves content from a specific site associated with the selected display feature, and rendering component 132 displays the retrieved content concurrently with the television program.

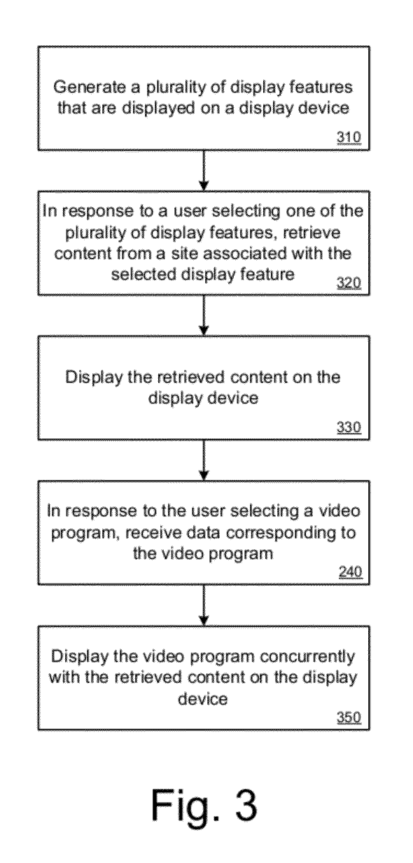

FIG. 3 illustrates another method for creating and displaying a media presentation, under an embodiment. Under one embodiment, a method such as described with FIG. 3 may be implemented using, for example, elements shown and described with FIG. 1. As such, reference to elements of FIG. 1 is intended to illustrate only suitable elements for performing a step or sub-step being described.

In step 310, the application platform 125 generates a plurality of display features (or Apps) that are displayed on a display device. In one embodiment, the display features are generated and displayed before any video program is played back on the display device, i.e., the media processing component 110 has not yet retrieved data corresponding to a video program from the content delivery network. The application platform 125 generates the Apps using data received from the web interface 120. The web interface 120 provides an interface between system 100 and the Internet or network, and retrieves data for generating the Apps. After the application platform 125 generates the Apps, rendering component 132 displays the Apps on the display device so that the user can browse and/or select one or more Apps.

In response to the user selecting one of the plurality of Apps, system 100 retrieves content from a site associated with that selected App (step 320). The UI device component 134 translates commands from a remote control device to enable the user to browse and/or select one or more Apps. When the user selects an App, the UI device component 134 relays the information to application services 130. Application services 130 communicates with the web interface 120 to retrieve content corresponding to the selected display feature from the Internet.

After retrieving content corresponding to the selected display feature, rendering component 132 displays the retrieved content on the display device (step 330). Once the retrieved content is displayed on the display device, the user may browse the retrieved content and/or select one or more of a plurality of links on the retrieved content.

In step 340, the user can request a video program for playback on the display device, and in response to that request, system 100 receives data corresponding to the video program. In one embodiment, the video program can be requested from an ordering page corresponding to the content delivery network. The user can browse the ordering page to view a plurality of video programs available from the content delivery network. The user can use the remote control device to browse the video programs available and select a video program for playback. The media presentation component 115 signals the media processing component 110 of the selection made by the user, and the media processing component 110 retrieves data corresponding to the video program from the content delivery network. In another embodiment, the user can request a video program by selecting a link that is found on the retrieved content. The link may be associated with a video program that is found on the Internet or network For example, if the user had selected the App for www.youtube.com, the retrieved content displayed on the display device would correspond to the website www.youtube.com. The user can browse the retrieved content and select a link corresponding to a video clip. In response to the user selecting a link that is found on the retrieved content (e.g., a music video), application services 130 communicates with the web interface 120 to retrieve data corresponding to the selected link from the Internet.

After receiving data corresponding to a selected video program, system 100 displays the video program concurrently with the retrieved content on the display device (step 350). For example, if the user selected a video program from an ordering page corresponding to the content delivery network, the media processing component 110 processes the data corresponding to the selected video program and sends the data to the media presentation component 115. The media presentation component 115 displays the video program on the display device. Presentation control 136 controls the media presentation to enable the video program to be displayed concurrently with the retrieved content. Depending on how the user customized the media presentation or how the default settings are configured, presentation control 136 can reduce the size of the viewing window of the displayed video program and/or move the location of the viewing window displaying the video program based on the requirements of the Apps and/or the retrieved content.

In one embodiment, when the video program is displayed on the display device, presentation control 136 can hide the retrieved content and/or the display features so that only the video program is displayed. The retrieved content and/or the display features would be hidden until the user makes a request to access the retrieved content and/or the display features. In another embodiment, presentation control 136 can pause/stop the video program and hide it so that only the retrieved content and/or the display features are displayed. The video program would be hidden until the user makes a request to continue the playback of the video program, or until the user hides the retrieved content and/or the display features.

In other embodiments, the steps in FIG. 3 can also apply to television/cable feeds from a television or cable provider.

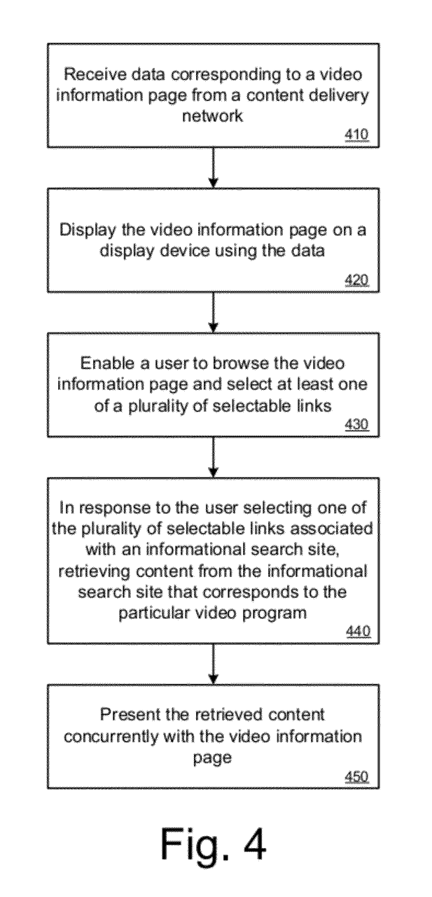

FIG. 4 illustrates a method for creating and displaying a media presentation with an informational search site, under an embodiment. Under one embodiment, a method such as described with FIG. 4 may be implemented using, for example, elements shown and described with FIG. 1. As such, reference to elements of FIG. 1 is intended to illustrate only suitable elements for performing a step or sub-step being described.

In step 410, system 100 receives data corresponding to a video information page from a content delivery network. The video information page can be accessed from an ordering page that is presented as part of the media presentation. As discussed above, the ordering page displays a list or a plurality of images of video programs that are available for playback from the content delivery network. For example, the image can be a movie poster or a DVD cover of the video program. A video program displayed on the ordering screen (as part of a list or as an image, for example) has a corresponding video information page associated with it. When a user selects a video program, information regarding the user's selection is sent to the content delivery network. The data corresponding to the video information page for that selected video program is then received by the media processing component 110.

The media processing component 110 processes the data corresponding to the video information page and relays the data to the media presentation component 115. The media presentation component 115 displays the video information page on the display device using the data (step 420). As discussed above, a video program has a corresponding video information page associated with it. In one embodiment, the video information page for a particular video program includes at least one of: (i) information about that video program, (ii) one or more images corresponding to that video program, (iii) one or more trailers of that video program, and (iv) an ordering display for ordering that video program. These features are selectable by a user using a remote control device and as a result of the user's selection, other corresponding pages may be displayed on the display device. In another embodiment, the video information page contains selectable links for navigating to other pages. For example, the video information page can have a section that gives detailed information about a particular video program. Some of the information can disclose the name of the actors/actresses starring in a movie, the name of the directors or producers, the genre, or the release date of the movie, etc. These features may also be selectable for allowing a user to navigate to other pages. If a user selects the name of the director of a particular movie, a page containing information about the director will be displayed as part of the media presentation.

In step 430, the user is enabled to browse the video information page and select at least one of the plurality of selectable links. If the user selects the link for viewing the trailer for a video program, application services 130 transmits information regarding this selection to the media presentation component 115. The media presentation component 115 communicates this information to the media processing component 110, and the media processing component 110 receives data corresponding to the trailer for the video program from the content delivery network. The user can browse the video information page by moving between pages by selecting various selectable links that are found on the page, or by going back to a previous page.

In one embodiment, one of the selectable links found on a video information page is associated with an informational search site. The informational search site can be an online encyclopedia, a wiki page like www.wikipedia.org, or the like. When the user is browsing a video information page corresponding to a particular video program from the content delivery network, the user can select a link associated with the informational search site. When the user selects that link, system 100 retrieves content from the informational search site that corresponds to the particular video program (step 440). For example, the user can access the ordering page related to video programs available from the content delivery network, and select a video information page corresponding to The Dark Knight (a motion picture). When the user browses the video information page for The Dark Knight, the user can select a link associated with the informational search site (e.g., Wikipedia®). When the user selects that link, application services 130 communicates information about the user selection to the web interface 120. The web interface 120 retrieves content corresponding to a www.wikipedia.org article about The Dark Knight and sends the content to application services 130.

The rendering component 132 displays the retrieved content that corresponds to a particular video program on the display device as part of the media presentation (step 450). The retrieved content is displayed concurrently with the video information page. The user can also browse the retrieved content by selecting one or more of a plurality of links that are found on the retrieved content to get to other pages found on the informational search site. Referring back to The Dark Knight example above, the user can browse the retrieved content corresponding to a www.wikipedia.org article about The Dark Knight. The retrieved content corresponding to the article contains over selectable links that enable a user to navigate from that page to another. The user can select a link (e.g., the name of an actor starring in the movie) and application services 130 will communicate information about the user selection to the web interface 120. The web interface 120 will retrieve content from the internet corresponding to a www.wikipedia.org page about the selected actor and sends this content to application services 130. This new page will be displayed by the rendering component 132 on the display device.

Other embodiments of the media presentation include an ordering page for a video program that enables a user to order (or purchase) the video program for playback. The ordering page may also have a selectable link for adding a video program to a wish list (e.g., make a notification that the user wants to order this movie at a later time). This wish list will contain a list of video programs that the user wants to order at a later time and can be edited by the user (e.g., add more video programs or delete an existing video program on the wish list). In some embodiments, the user can view an ordering page for a video program that is not yet available for playback from the content delivery network. The user may add the video program to the wish list and system 100 is configured to notify the user when the video program is available for playback.

In one embodiment, the ordering page contains a link for a trailer page that displays trailers available for playback from the content delivery network. The trailer page can have a plurality of trailers corresponding to video programs that are available for playback from the content delivery network (or for video programs that will be available for playback from the content delivery network at a later time). The user can select a trailer for playback and the trailer will be played back on the display device using system 100 (as discussed previously). In some embodiments, once the trailer has finished playing, another trailer can be automatically played back after. Other embodiments allow for the user to make a notification on whether he or she likes the trailer (e.g., a thumbs up or a thumbs down). The user can be reminded to order the video program at a later time. In another embodiment, system 100 will maintain a user search and viewing history of trailers that the user has selected and/or viewed to determine user preference. System 100 will use this history and configure the trailer page to display trailers for video programs that fits the user's preference.

### Social Networking Usage

According to some embodiments, a user's video on demand experience can be shared with the user's social networking environment using the display device on which the content is provided. As discussed previously, an App can correspond to a social networking site, such as Facebook®, Twitter®, MySpace®, or other social networking sites available on the Internet. A user can access the media presentation and select a social networking site (i.e., select an application) to access while a video program is concurrently displayed on a display device. The user can launch or perform other functions using the selected application by using a remote control device. The remote control device can, for example, provide binary user input (e.g., selection input) that can be interpreted as (i) launch application, or (ii) enter input for application. In one embodiment, the remote control device can comprise an alphanumeric keyboard for enabling user input in an application. In another embodiment, the media presentation can display an alphanumeric keyboard on the display device to enable a user to select different inputs for inputting values or letters in an application.

When a user accesses the application for a shared social networking site, such as Facebook®, for example, the user can browse the retrieved content corresponding to www.facebook.com, and perform other functions on the retrieved content. In one embodiment, the user can browse different notifications and his or her own profile, “write” on a friend's wall, or update his or her own profile or profile status using the remote control device. The user can perform these actions on the media presentation while concurrently viewing a video program being displayed on the display device.

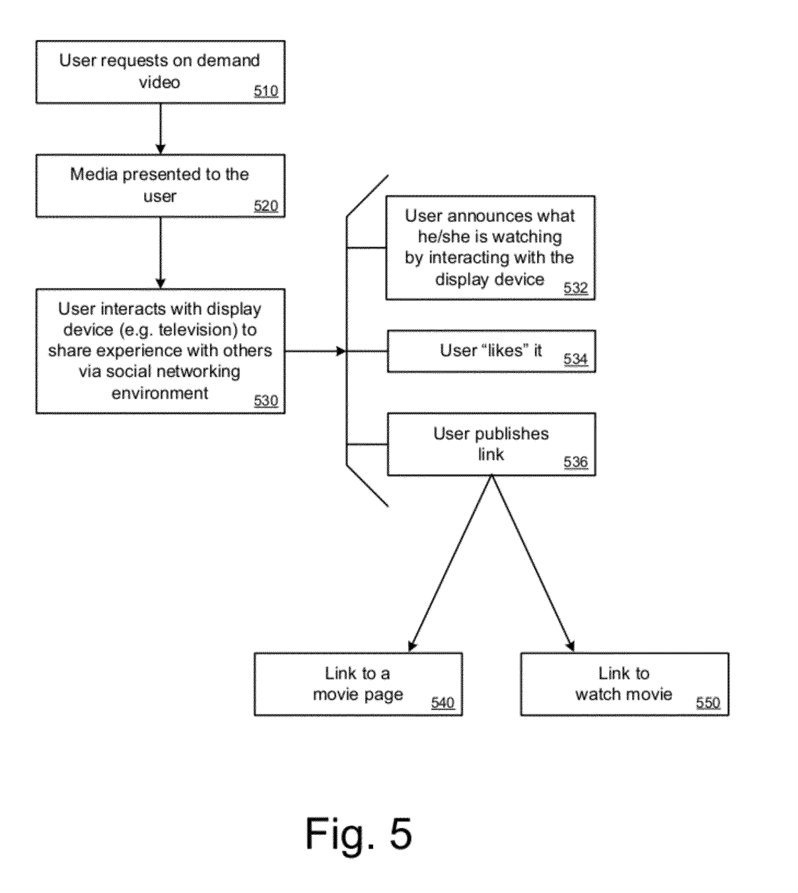

FIG. 5 illustrates a method for interacting with a social networking environment on the media presentation, according to an embodiment. A method such as described with FIG. 5 may be implemented using, for example, elements shown and described with FIG. 1. As such, reference to elements of FIG. 1 is intended to illustrate only suitable elements for performing a step or sub-step being described.

In step 510, the user can request to view or playback a video program on demand. In one embodiment, the user can request the video program by browsing an ordering page related to video programs available from the content delivery network. The user can select a video program, such as a movie, to playback on the display device. In another embodiment, the video program can be streamed from the content delivery network to the display device for on demand viewing.

System 100 receives the data corresponding to the requested video program from the content delivery network, processes the data, and displays the requested video program on the display device (step 520). As discussed previously with respect to FIGS. 1-4, the media presentation component 115 can receive the processed data corresponding to the requested video program and display the video program on the display device. Display features (alternatively referred to as Apps) can also be concurrently displayed on the display device and are selectable by the user using a remote control device.

The user can access the media presentation while the video program is displayed on the display device and select one or more Apps to access corresponding sites associated with the Apps. One or more of these Apps can correspond to a social networking site. The user can interact with the display device to share his or her experience with other social acquaintances via the social networking environment (step 530). As previously discussed, a user can browse the retrieved content corresponding to a social networking site and perform other functions on the retrieved content. Sub-steps 532, 534 and 536 illustrate embodiments of the user interaction with the display device.

In step 532, the user can interact with the display device to announce on the social networking environment what he or she is viewing. For example, if the user is viewing a movie on the display device, the user can access the social networking environment to update his or her profile/status to show what he or she is currently viewing. In one embodiment, the user can select a feature that automatically updates his or her status with what the user is watching. This update can include the title of the video program and/or an image corresponding to the video program. In another embodiment, the user can manually update his or her profile/status to announce on the social networking environment what he or she is viewing. In one example, if the user selects the Twitter® App while she is viewing the movie “Toy Story”, the user can interact with the display device to “tweet” that she is viewing “Toy Story.”

In another embodiment, the user can interact with the display device to make a notification whether or not the user “likes” or “dislikes” the video program she is viewing (step 534). The notification can be available for other friends of the user's social networking environment to see. The user's friends may also comment on the notification and/or also select whether he or she “likes” or “dislikes” the video program. In one embodiment, there can be a rating system that the user can select regarding the video program that the user is viewing. This can provide feedback to others (e.g., the user's friends and/or acquaintances) on the social networking environment regarding the video program.

The user can also interact with the display device to share his or her experience with others on the social networking environment by publishing a link for the video program the user is viewing (step 536). The user can publish a link on his or her profile/status or a notification, for example, so that others on the social networking environment can view the profile/status or notification and select the link. In one embodiment, the user can select a feature on the media presentation to automatically update his or her profile/status or notification with the link for the video program the user is watching. In some embodiments, the link can be a link to a movie page (540) for more information about the movie the user is viewing. For example, the link can be to a movie page available on the social network website or to a movie information page like www.imdb.com. A user's friend on the social networking environment can select on the link to view information about the movie the user is viewing.

In another embodiment, the link can be a link for the playback of the movie (step 550). The user can publish a link for playback of the movie that he or she is watching on the social networking environment. When the user's friend on the social networking environment selects the link for the playback of the movie, the friend can view a movie page to order (or purchase) the movie. In one embodiment, if the user's friend is connected to the content delivery network that provides the movie, the user's friend may be able to order or purchase the movie for playback. In other embodiments, the selecting the link can enable automatic playback of the movie if the person selecting the link is authorized to view the movie.

Using the media presentation, the user can interact with the display device to share his or her experience with others via the social networking environment.

### Hardware Diagram

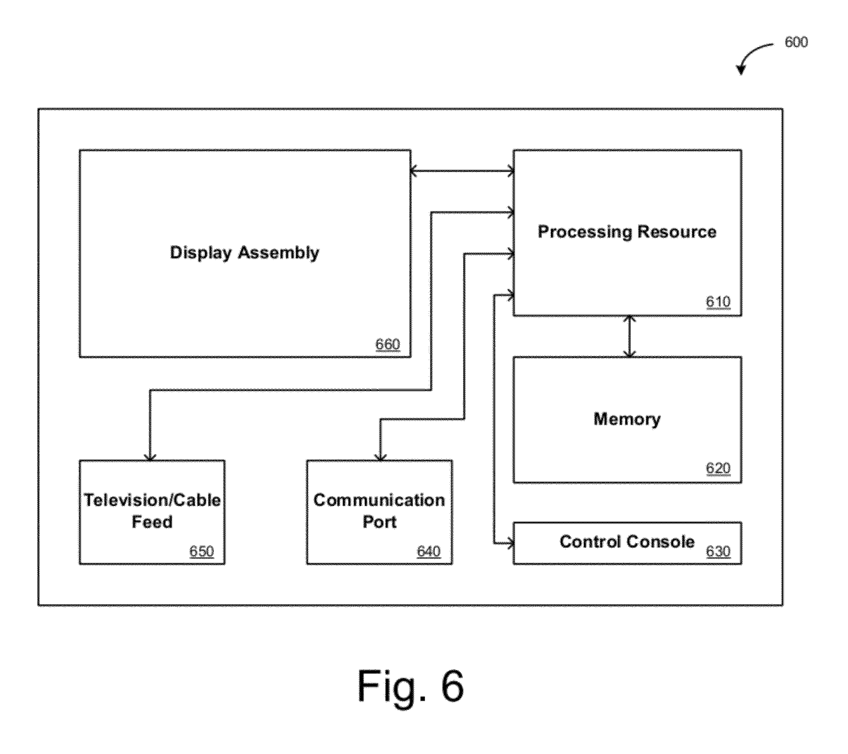

FIG. 6 is a simplified hardware illustration of a device for implementing an architecture such as described with FIG. 1, under an embodiment. In FIG. 6, a device 600 includes a processing resource 610 (e.g., one or more processors), one or more memory 620 for storing applications, display features, and media presentations and data used by the applications (e.g., Flash memory, RAM, hard drive, portable storage units, etc.), a control console 630 for enabling a user to control the device 600, a communication port 640, a television/cable feed 650, and a display assembly 660. In one embodiment, a dedicated remote control device for device 600 can communicate with the control console 630 to enable a user to control the device 600. The communication port 640 can be a wireless communication port that is configured as a Wi-Fi port (such as for use in communicating on the IEEE 802.11(b) or (g) standards) or a Bluetooth communication port, for example, or as an Ethernet port. The television/cable feed 650 can be a cable feed, a satellite feed, an over air feed, or other types that are broadcasted by a provider. The display assembly 660 comprises a display device that is a cathode ray tube (CRT) display, a digital light processing (DLP) display, a liquid crystal display (LCD), a plasma display, a light emitting diode (LED) display, or other various types of display. The processing resource 610 may execute to retrieve instructions for implementing system 100 (FIG. 1).

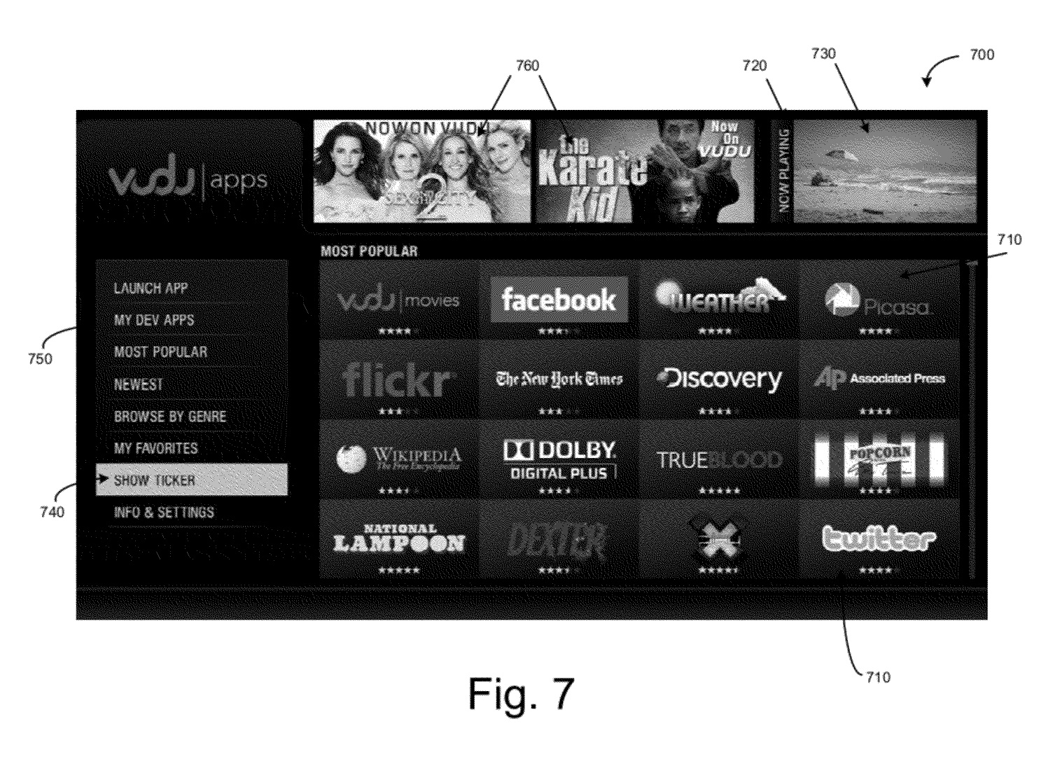

FIGS. 7-18 illustrate media presentations under an embodiment. The illustrations described with FIGS. 7-18 may be implemented using, for example, elements shown and described with FIG. 1. As such, reference to elements of FIG. 1 is intended for illustration purposes.

FIG. 7 illustrates a media presentation that includes a plurality of display features, under an embodiment. As described previously, media presentation 700 can be displayed on a display device. In the embodiment provided, media presentation 700 includes a plurality of different display features 710 and a window 720 concurrently displaying a video program 730. Some of the display features 710 are represented by different graphic images corresponding to a specific site associated with that display feature and can be selectable by a user (e.g., the “Facebook” display feature can correspond to www.facebook.com, while the “AP Associated Press” display feature can correspond to www.ap.org).

As discussed previously, application platform 125 can generate the display features 710 and rendering component 132 can display the display features 710 as part of the media presentation. Media presentation component 115 concurrently displays a displayed video program 730 as part of the media presentation. In one embodiment, presentation control 136 communicates with the media presentation component 115 to control the media presentation by changing the viewing size of the video program 730 and moving the video program 730 to the window 720 in the upper right hand corner of the media presentation 700. In another embodiment, the television/cable processing component 140 displays a television program concurrently with the display features 710.

In one embodiment, media presentation 700 includes options to enable a user to select a different view for presenting the display features 710 on the display device by selecting “SHOW TICKER” option 740 on the left menu bar of media presentation 700. The “SHOW TICKER” view display the display features 710 like a news ticker instead of a full display view of the display features 710 that are organized in rows and/or columns. Media presentation 700 can also include a menu bar 750 that enables the user to select different options and/or views for managing or configuring media presentation 700.

In another embodiment, system 100 can display different advertisements showing a user what new video programs are available for playback from the content delivery network. The advertisements 760 can be selectable by the user. In response to the user selecting an advertisement 760, system 100 can retrieve a video information page corresponding to the advertisement 760 and display the video information page on the display device.

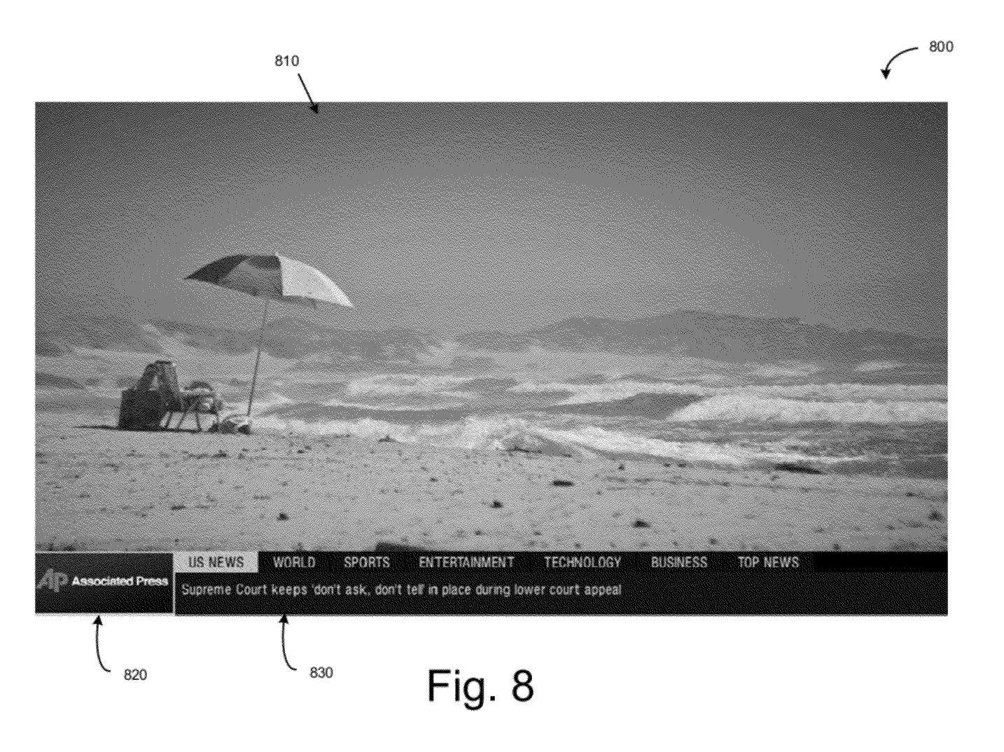

FIG. 8 illustrates a media presentation under another embodiment. Media presentation 800 includes a video program 810 that is displayed concurrently with a selected display feature 820. In one embodiment, the media presentation component 115 displays the video program 810 on the display device and the rendering component 132 concurrently displays the retrieved content 830 as part of the media presentation 800. For example, in FIG. 8, the user can browse the retrieved content 830 corresponding to the selected display feature, “AP Associated Press” by choosing different news categories (e.g., World, Sports, Entertainment). Because the news stories available from the website www.ap.org can be presented on media presentation 800 concurrently with the video program 810, the user can browse and/or select a news story while watching the video program 810.

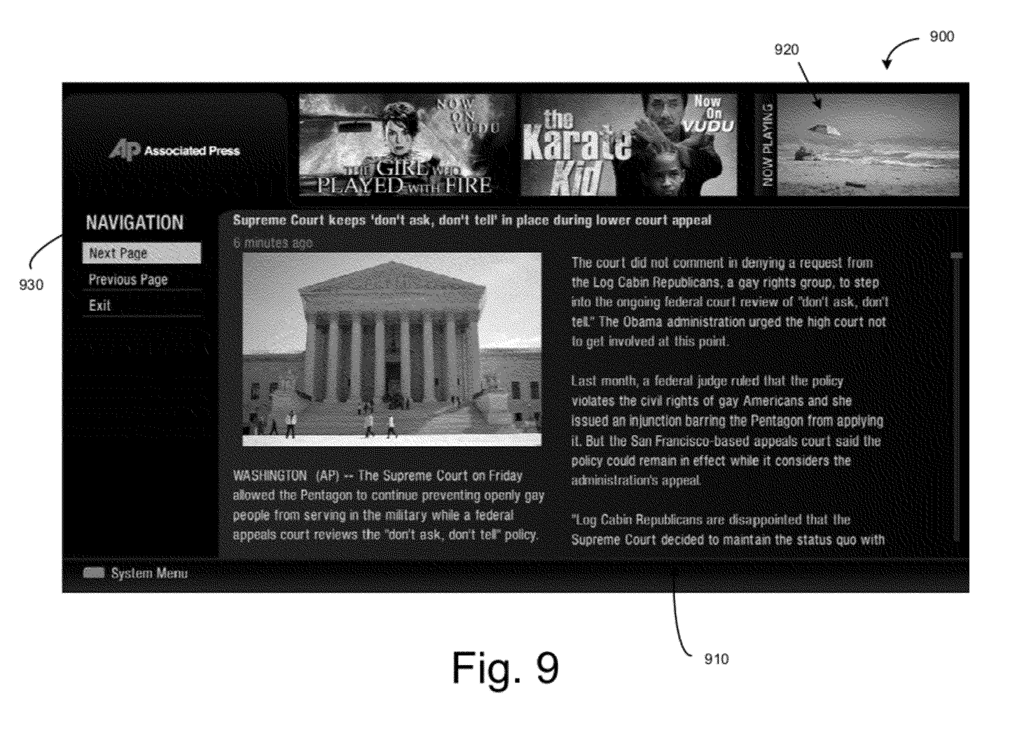

FIG. 9 illustrates retrieved content corresponding to a news article under an embodiment. Referring back to FIG. 8 for clarification, if a user selected a news headline from the retrieved content 830, such as the story titled “Supreme Court keeps ‘don't ask, don't tell’ in place during lower court appeal,” system 100 can display the news story as part of media presentation 900 on the display device. As described with FIG. 1, Application services 130 can communicate with the web interface 120 to retrieve content from the Internet 160 in response to the user selection. The rendering component 132 displays the retrieved content 910 (a news article, for example) as part of the media presentation 920. In one embodiment, the content of the retrieved news story 910 can be displayed concurrently with the video program 920. Media presentation 900 can also have navigation links 930 that enable the user to move to the next page or go back to a previous page.

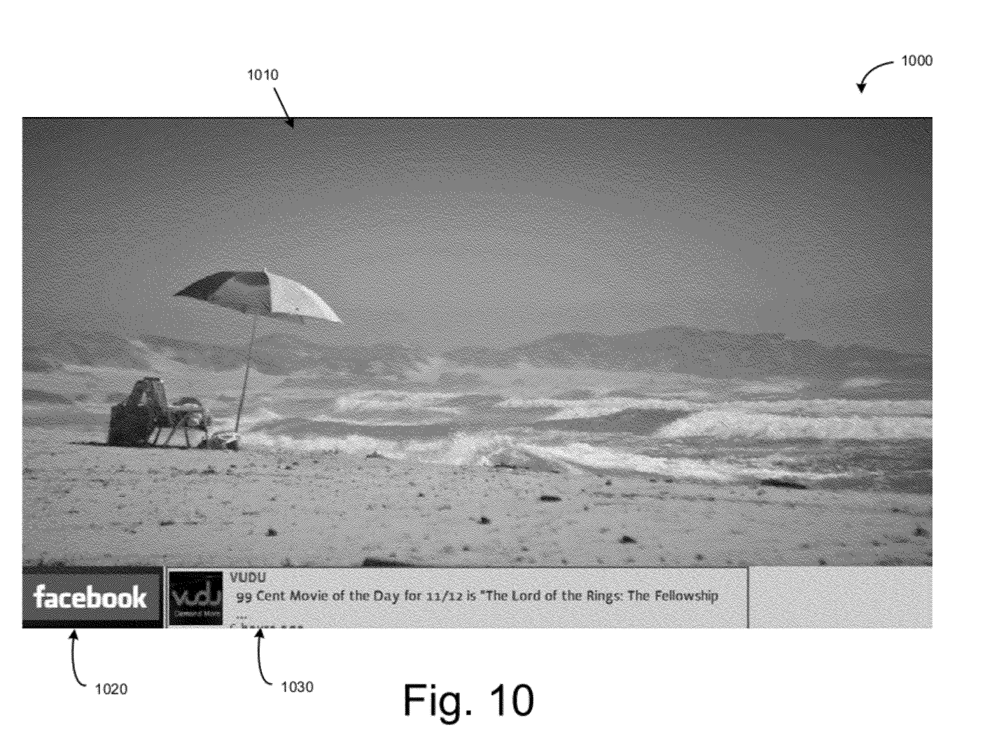

FIG. 10 illustrates a media presentation that has a display feature for a social website, according to an embodiment. Like FIG. 8, media presentation 1000 includes a video program 1010 that is displayed concurrently with a selected display feature 1020. For example, the selected display feature can be the Facebook App, which corresponds to www.facebook.com. Media presentation 1000 can include retrieved content 1030 corresponding to the home page or the profile page of the user from www.facebook.com. The video program 1010 can be displayed by the media presentation component 115 and the retrieved content 1030 can be concurrently displayed by the rendering component 132.

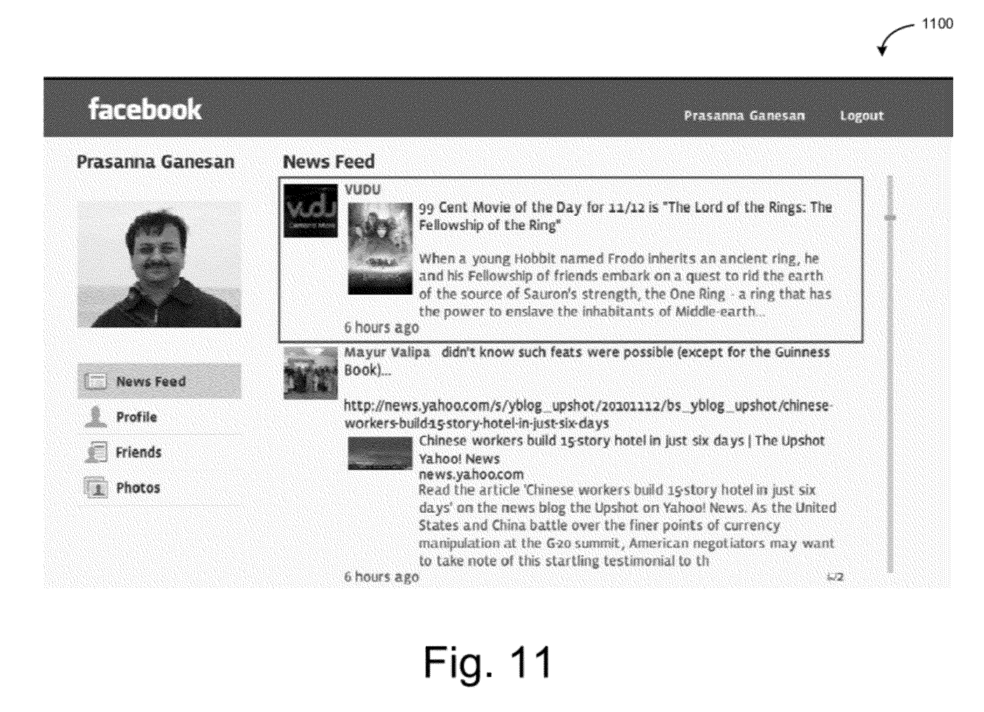

FIG. 11 illustrates retrieved content corresponding to a profile page of a user, according to an embodiment. Media presentation 1100 shows a home page of a user that corresponds to a social website, such as www.facebook.com. Media presentation 1100 can be displayed in response to the user launching or selecting the display feature corresponding to www.facebook.com. In one embodiment, media presentation 1100 can display the profile page on the display device without displaying a video program. Referring to FIG. 5 for clarification, the user can interact with the display device to share his or her experience with others via the social networking environment. For example, the user can post a notification on his profile or view other users' experience via the social network.

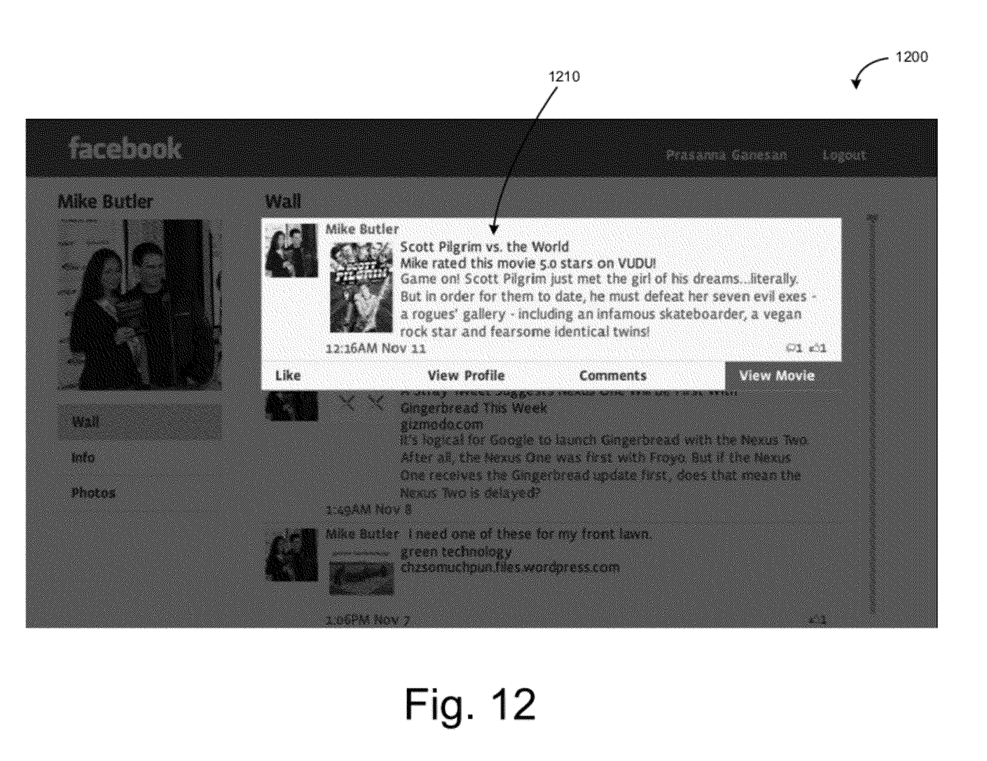

FIG. 12 illustrates another retrieved content corresponding to a social website, under another embodiment. Media presentation 1200 shows a profile page of a friend or another individual that is linked to the user on the social website, such as www.facebook.com. The user can browse a friend's profile page and can also select different posts and/or notifications available on the friend's profile page or wall. For example, the user's friend “Mike Butler” can post information corresponding to a video program that he had previously watched or was previously watching at the time of posting. The user can select the post 1210 corresponding to a video program, and can perform different actions (e.g., “like” it, view profile, comment on it, or view the movie).

As described with FIG. 5, the user can interact with the display device to share his or her experience with other social acquaintances via the social networking environment (as described with step 530). For example, Mike Butler (a Facebook user) posted a notification or updated his profile by writing about the movie “Scott Pilgrim vs. The World” in the post 1210 (as described with step 536). Another user, such as Prasanna Ganesan, can navigate to Mike Butler's page and interact with the display device to tell Mike Butler that he likes the movie (as described with step 534) or can comment about the movie.

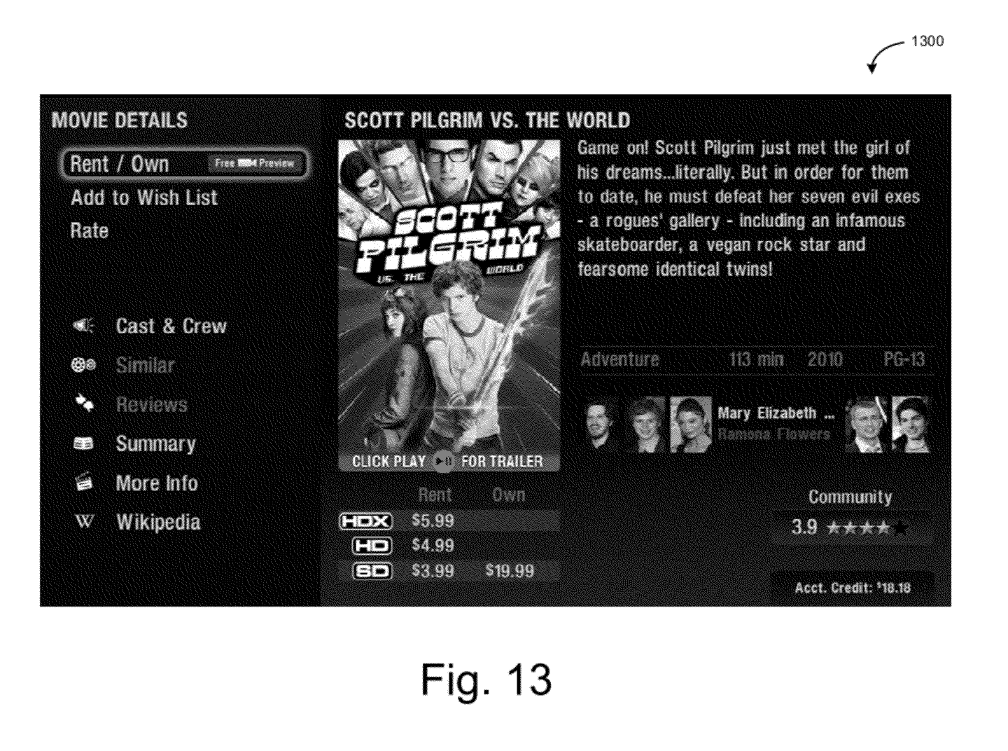

FIG. 13 illustrates a video information page under an embodiment. Media presentation 1300 shows a video information page for “Scott Pilgrim vs. The World.” Referring to FIG. 12 for clarification, media presentation 1300 can be displayed by system 100 in response to the user selecting the “View Movie” option from the post 1210 for “Scott Pilgrim vs. The World.” Although the post 1210 is available on a profile page or a home page of a user (or a friend) on a social network, such as www.facebook.com, system 100 can retrieve video information page data corresponding to the selected movie from the content delivery network 170. As discussed previously, the video information page displayed with media presentation 1300 contains a variety of different information relating to the selected movie. The user may also order the movie (either rent or purchase) for playback from the video information page.

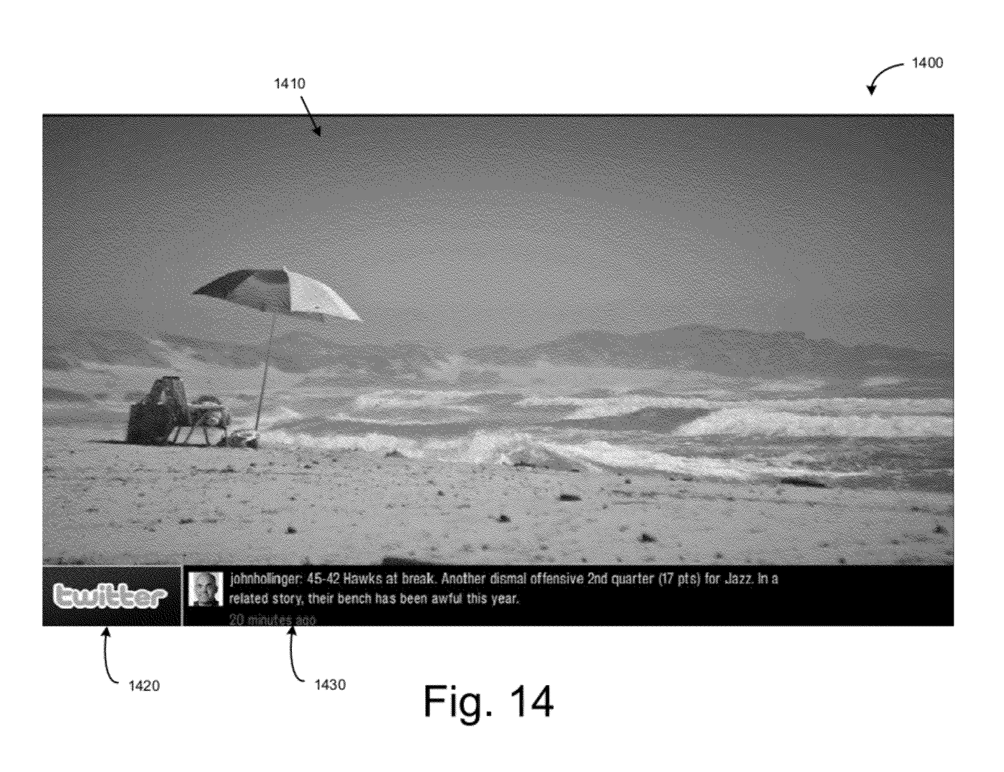

FIG. 14 illustrates a media presentation that has a display features for another social website, according to an embodiment. Like FIG. 10, media presentation 1400 includes a video program 1410 that is displayed concurrently with a selected display feature 1420. For example, the selected display feature can be the Twitter App, which corresponds to www.twitter.com. Media presentation 1400 can also include retrieved content 1430 corresponding to a friend's post or tweet (or a tweet of another socially linked individual) that is available from the website, www.twitter.com.

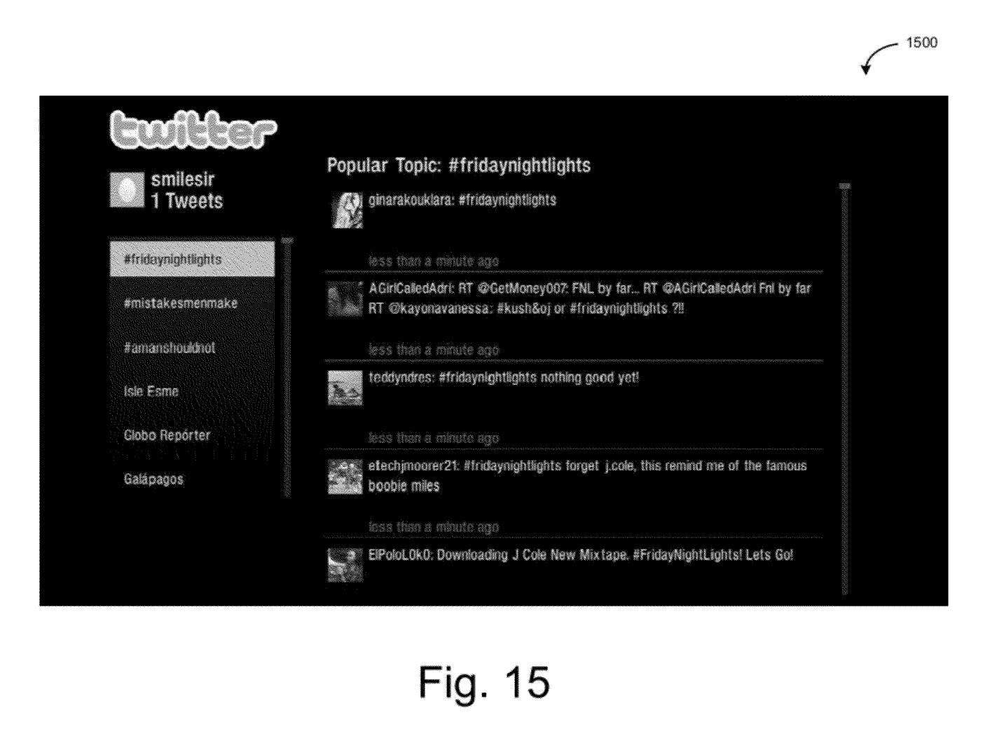

FIG. 15 illustrates retrieved content corresponding to a social website, according to an embodiment. In another embodiment, when the display feature for Twitter is selected, system 100 can display media presentation 1500 to show the retrieved content without displaying a video program. For example, presentation control 136 can pause or stop the displayed video program so that the rendering component 132 displays the retrieved content without displaying the video program.

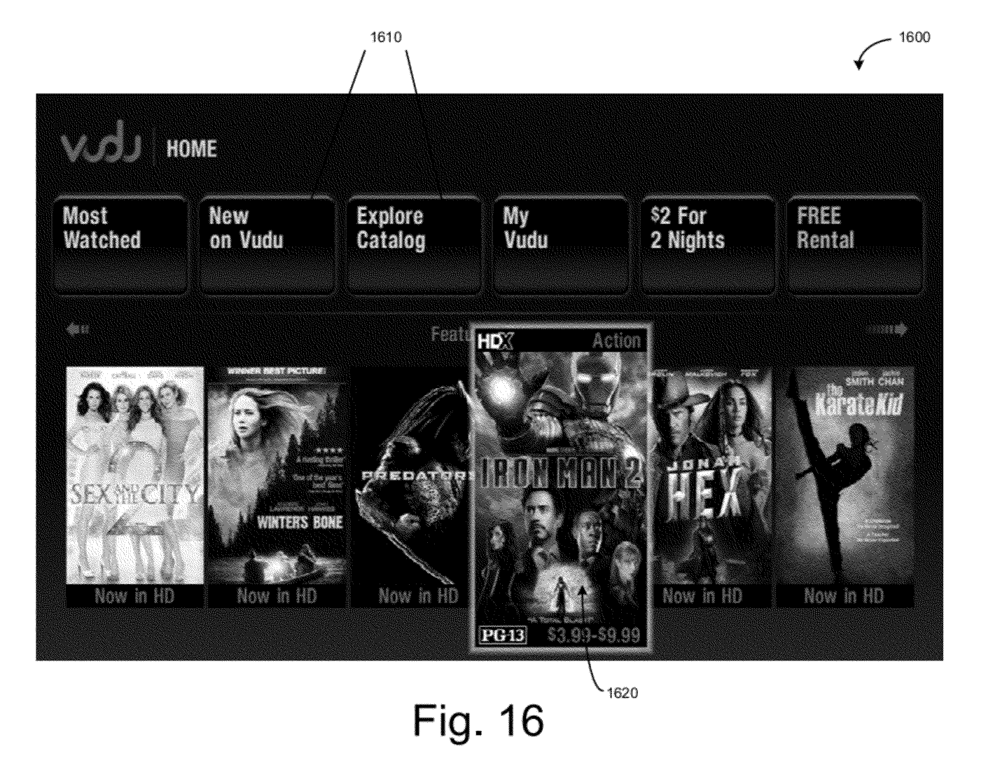

FIG. 16 illustrates an ordering page with various video programs available from a content delivery network, under an embodiment. In one example, media presentation 1600 can be an ordering page for video programs available from the content delivery network 170. Referring back to FIG. 7 for clarification, media presentation 1600 can be displayed by system 100 in response to a user selecting a display feature for ordering video programs from the content delivery network 170, such as Vudu Movies. Media presentation 1600 shows different movies available for playback on the display device. In some embodiments, the movies can be presented as movie posters or DVD covers, for example. The ordering page may also include different links 1610 and/or options for browsing the ordering page. Some embodiments enable the user to scroll up and down (if the movies are arranged in a list, for example), or scroll left and right using a dedicated remote control.

In one embodiment, when the user browses the different video programs available from the content delivery network 170 using a remote control device, media presentation 1600 highlights the movie or video program that the cursor from the remote device is on. In one embodiment, the highlighted movie 1620 can be enlarged compared to the other movies available on the ordering page.

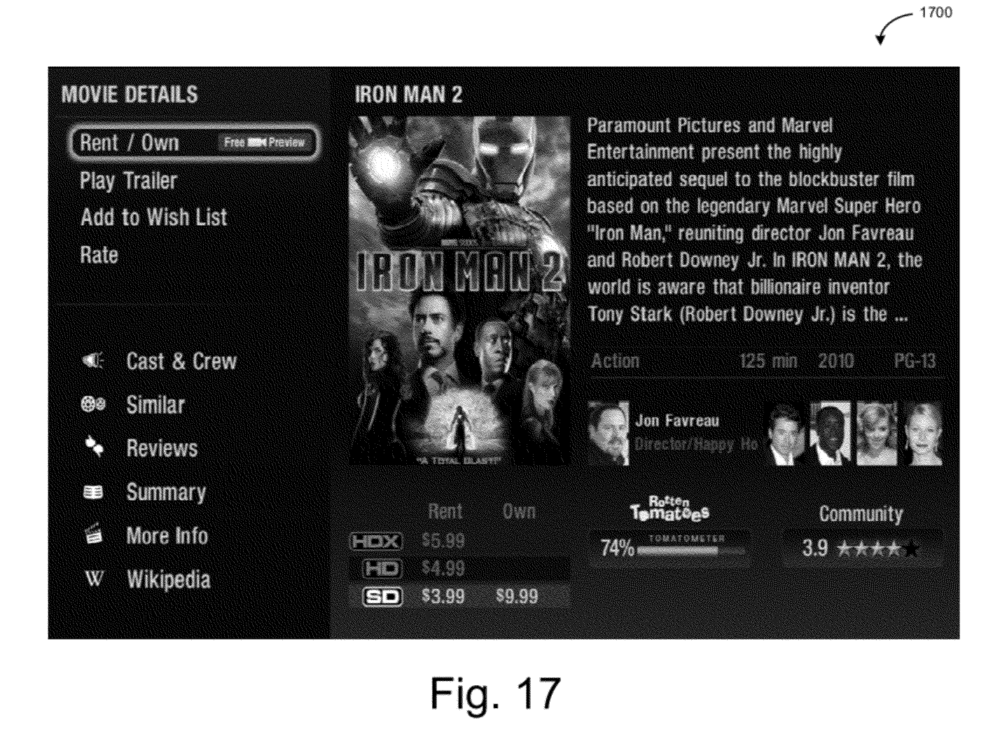

FIG. 17 illustrates a video information page under another embodiment. If the user selected the movie “Iron Man 2” from the ordering page (see FIG. 16), system 100 will display a video information page corresponding to the selected movie. Media presentation 1700 shows a video information page for “Iron Man 2.” As discussed previously, the video ordering page includes a variety of different information about the movie, such as the summary of the movie, the running time, the actors starring in the movie, reviews, etc. The video information page is displayed by the media presentation component 115 after receiving data from the media processing component 110. The user may rent or purchase the movie from the video information page for playback on the display device. In one embodiment, the video information page may also have a link for a “wish list,” as discussed previously. The video information page may also include a link for “Wikipedia,” an informational search site.

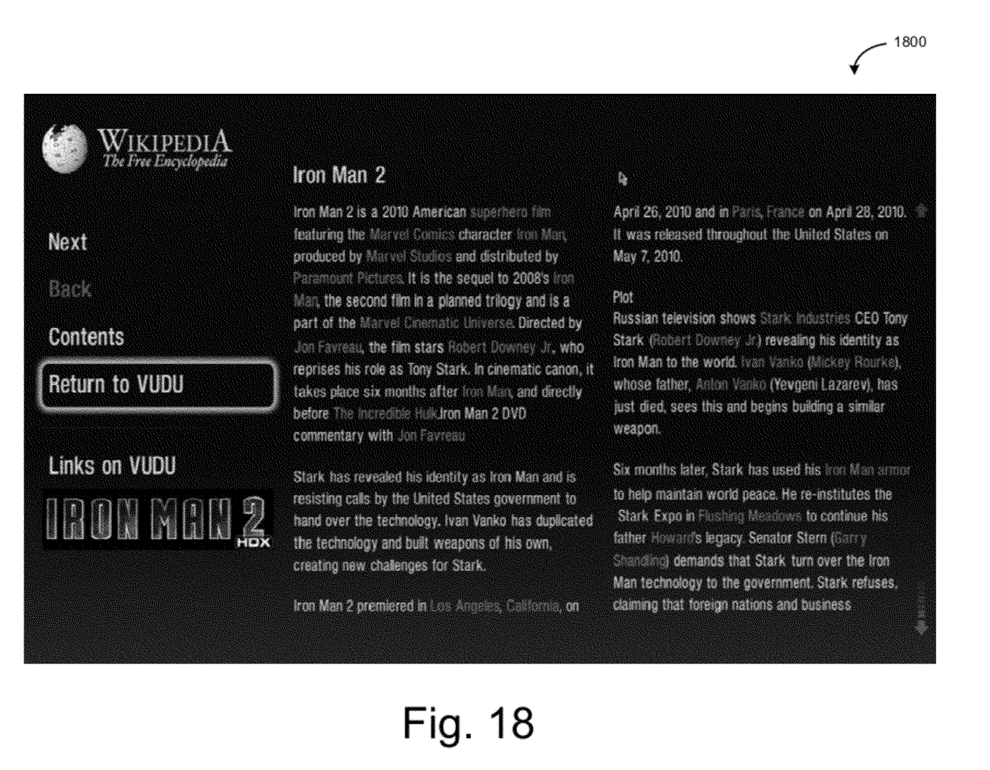

FIG. 18 illustrates an informational search site, according to an embodiment. Media presentation 1800 can display content from an informational search site, such as www.wikipedia.org, from a video information page. The content from the video information page can be displayed as a result of the user selecting a link associated with the informational search site (as described with step 440 in FIG. 4). As discussed previously, in one embodiment, the video information page (such as the one illustrated in FIG. 17) can include a link for “Wikipedia.” Referring back to FIG. 17, the video information page for “Iron Man 2” has a link for “Wikipedia,” so that a user can select the link and view content corresponding to the movie “Iron Man 2” available from the informational search site. Media presentation 1800 shows the retrieved content corresponding to the movie “Iron Man 2.” In some embodiments, the retrieved content can be the same content found from the article about “Iron Man 2” from the website www.wikipedia.org. In other embodiments, the retrieved content can be different, such as a reduced version of the actual article found on the Internet. The user can browse media presentation 1800 to scroll down and continue reading, or can select one or more of the plurality of links found on the retrieved content to get to other Wikipedia articles. For example, the user can select the selectable link “Jon Favreau,” to get to another Wikipedia article page about the actor and director Jon Favreau.

### CONCLUSION

Although illustrative embodiments have been described in detail herein with reference to the accompanying drawings, it is to be understood that the embodiments are not limited to those precise drawings. As such, many modifications and variations will be apparent to practitioners skilled in this art. Furthermore, it is contemplated that a particular feature described either individually or as part of an embodiment can be combined with other individually described features, or parts of other embodiments, even if the other features and embodiments make no mention of the particular feature. Thus, the absence of describing combinations should not preclude the inventor from claiming rights to such combinations.

What is claimed is:

1. A method for creating and displaying a media presentation, the method being performed by one or more processors and comprising:
receiving data corresponding to a video program from a content delivery network;
displaying the video program using the data on a display device that receives the data from the content delivery network;
generating a plurality of display features that are displayed concurrently with the displayed video program, at least some of the plurality of display features each being selectable to cause the display device to retrieve content from a third party site associated with the display feature;
in response to a user selecting one of the at least some of the display features, retrieving content from a corresponding third party site associated the selected display feature; and
displaying the retrieved content concurrently with the video program.

2. The method of claim 1, further comprising enabling the user to interact with a dedicated remote control device of the display device in order to navigate the media presentation and select an individual display feature from the plurality of display features.

3. The method of claim 1, wherein receiving data corresponding to the video program includes receiving the data by streaming.

4. The method of claim 1, wherein displaying the video program includes displaying the video program in high-definition video quality.

5. The method of claim 1, wherein the video program is at least one of: (i) a movie, (ii) a movie trailer, (iii) a television program, or (iv) a video clip.

6. The method of claim 1, wherein each of the plurality of display features is a selectable graphic image corresponding to a specific site associated with each of the plurality of display features.

7. The method of claim 1, wherein retrieving content from a specific site does not interrupt the displaying of the video program.

8. The method of claim 1, wherein retrieving content from a specific site automatically decreases the viewing size of the displayed video program.

9. The method of claim 1, further comprising enabling the user to concurrently browse the retrieved content while displaying the video program.

10. The method of claim 9, wherein enabling the user to concurrently browse the retrieved content includes enabling the user to select a second video program for playback.

11. The method of claim 1, further comprising enabling the user to concurrently browse a video program ordering page while displaying the video program.

12. The method of claim 11, wherein the video program ordering page includes a plurality of video programs available for ordering and for playback from the content delivery network.

13. The method of claim 12, wherein enabling the user to concurrently browse the video program ordering page includes enabling the user to select a second video program for playback from the plurality of video programs available.

14. The method of claim 13, further comprising, in response to the user selecting a second video program for playback, (i) receiving data corresponding to the second video program, and (ii) displaying the second video program on the display device using the data corresponding to the second video program.

15. The method of claim 13, wherein enabling the user to select a second video program for playback from the plurality of video programs available includes (i) purchasing the second video program if the second video program is available on the content delivery network, or (ii) adding the second video program to a wish list if the second video program is not yet available on the content delivery network.

16. The method of claim 15, further comprising if the second video program is added to the wish list, notifying the user that the second video program is available for playback when the second video program is available from the content delivery network.

17. A method for creating and displaying a media presentation, the method being performed by one or more processors and comprising:
generating a plurality of display features that are displayed on a display device, wherein each of the plurality of display features is selectable to cause the display device to retrieve content from a third party site associated with that display feature;
in response to a user selecting one of the plurality of display features, (i) retrieving content from a third party site associated with the selected display feature, (ii) displaying the retrieved content on the display device, and (iii) enabling the user to browse the retrieved content;
enabling the user to browse the media presentation and select at least one of a plurality of video programs for playback, the video program being provided by a content delivery network;
in response to the user selecting a video program, receiving data corresponding to the selected video program from the content delivery network; and
displaying the selected video program using said data, the video program being concurrently displayed with the retrieved content on the display device.

18. The method of claim 17, further comprising enabling the user to concurrently browse the retrieved content while displaying the selected video program.

19. The method of claim 17, wherein receiving data corresponding to the selected video program includes receiving said data by streaming.

20. A method for creating and displaying a media presentation, the method being performed by one or more processors and comprising:
receiving data corresponding to a first video information page from a content delivery network;
displaying the first video information page on a display device using the data corresponding to the first video information page, wherein the first video information page includes (i) information about the specific video program, and (ii) a plurality of selectable links;
enabling a user to browse the first video information page and select at least one of the plurality of selectable links;
in response to the user selecting one of the plurality of selectable links associated with a third party informational search site, retrieving content from the third party informational search site that corresponds to the specific video program;
presenting the retrieved content on the display device, wherein presenting the retrieved content includes providing one or more selectable features related to at least a portion of the retrieved content; and
in response to the user selecting one of the one or more selectable features, (i) receiving data corresponding to a second video information page from the content delivery network, and (ii) displaying the second video information page corresponding, the second video information page being related to the selected one of the selectable features.
